(19) United States
(12) Patent Application Publication
(10) Pub. No.: US 2010/0039820 A1
(43) Pub. Date: Feb. 18, 2010

(54) LIGHTING UNIT HOUSING

(76) Inventor: John Peter Holland, Stockholm (SE)

Correspondence Address: LAUBSCHER & LAUBSCHER, P.C., 1160 SPA ROAD, SUITE 2B, ANNAPOLIS, MD, 21403, US

(21) Appl. No.: 12/526,295

(22) PCT Filed: Feb. 25, 2008
(86) PCT No.: PCT/GB2008/050123

§ 371 Date: Sep. 28, 2009

(30) Foreign Application Priority Data
Feb. 23, 2007 (GB) 0703613.0

(51) Int. Cl. F21V 9/00

(52) U.S. Cl. 362/293

(57) ABSTRACT

A housing is provided for connection between a replaceable lighting unit and a standard lighting unit socket. The housing includes a main body, a holding mechanism for releasably holding a lighting unit and an openable cover for covering a lighting unit held by the holding mechanism. The cover includes a UV filter and the non integral component parts of the housing are held together mechanically without adhesive, such that the housing provides a minimal chemical and UV emission signature.

The present invention relates to a lighting unit housing, and more particularly to a reusable housing having a male socket adaptor for connecting a lighting unit, such as a halogen bulb, to a standard female light socket, for example an Edison or bayonet socket.

In this connection, there are a number of conventional lighting units known in the art, including standard incandescent lighting units (i.e. glass bulbs containing a wire filament under vacuum or surrounded by a low-pressure noble gas), halogen lighting units (i.e. quartz bulbs containing a wire filament surrounded by a halogen gas), fluorescent lighting units (i.e. gas discharge tubes filled with a gas containing argon and mercury vapor) and neon lighting units (i.e. gas discharge tubes filled with neon gas).

All such known lighting unit types emit heat when in use. This is particularly the case with incandescent light bulbs, although halogen and fluorescent light bulbs and tubes can also get very hot. Indeed, even after relatively short periods of use, the lighting unit itself, including its associated male connector part, as well as the socket and associated mouldings, tend to become very hot.

Conventional lighting unit constructions often use resins and adhesives to seal and connect components, for example, between the glass cover and the male connector part. Plastics and chemical coatings are also commonly used in these constructions. However, there is evidence that, when heated, such materials can give off, or “off-gas”, poisonous or otherwise noxious emissions. For example, when heated, some of the adhesives and resins used in the base of certain conventional lighting units have been found to give off quantities of dangerous chemicals such as phenol, cresol, toluene, butanol, benzodioxin and formaldehyde, some of which are carcinogens and/or which can cause fertility problems. Such chemicals may also induce nerve-related symptoms in people, especially those who are asthmatic, or otherwise sensitive to pollutants.

It is therefore an object of the present invention to attempt to provide an apparatus which alleviates such problems.

According to a first aspect of the present invention there is provided a housing for connecting between a replaceable lighting unit and a standard lighting unit socket, the housing comprising: a main body; holding means for releasably holding a lighting unit; and an openable cover for covering a lighting unit held by said holding means; wherein the cover has a UV filter and the non integral component parts of said housing are held together mechanically without adhesive, for providing a minimal chemical and UV emission signature.

In this way, the component parts of the present invention are assembled and held together without the use of any adhesives, such that off-gassing from the housing assembly is minimized. In this regard, the term “standard lighting unit socket” is intended to cover any female socket such as for Edison and bayonet type light bulbs. As such, the present invention allows a replaceable lighting unit to be connected and used with a standard lighting unit socket in a low emission way thereby producing the smallest possible chemical signature. Moreover the UV filter in the cover reduces likelihood of harm from UV radiation and the combination effects of UV, chemicals and other sources of radiation. Furthermore, the housing thereby produced is reusable in that it allows the replacement of the lighting unit. Therefore, if the lighting unit fails or needs replacing, this will not require replacement of the entire housing itself.

Conveniently, the cover is formed of glass having a coating for absorbing at least 95% of ultra-violet rays. For example, the coating may be a vacuum coating of titanium silicon alloy. In this way, the emission of harmful UV radiation can be significantly reduced to achieve the smallest possible UV signature.

Conveniently, the housing further comprises a male socket connection means provided on said body for connecting to a standard female lighting unit socket. Said male socket connection means may be a screw fitting for connection to a screw-type female lighting unit socket. Alternatively, the male socket connection means is a bayonet fitting for connection to a bayonet-type female lighting unit socket.

Conveniently, said body is formed of a ceramic. When heated, such a material does not tend to produce harmful emissions, thereby minimizing the chemical signature of the housing.

Conveniently, the housing further comprises electrical contact means for connecting a lighting unit held in said holding means to electrical contacts in said lighting unit socket, said electrical contact means being attached to the body by snap-lock connection. Conveniently, the snap-lock connection prevents detachment of the electrical contact means once it is attached to the body. Conveniently, the snap-lock connections serve as tamper evidence if an attempt is made to detach the electrical contact means from the body. In this way, a sturdy tamper-proof construction is provided without the need for adhesives.

Conveniently, said holding means is attached to the body by snap-lock connection.

Conveniently, the snap-lock connection prevents detachment of the holding means once it is attached to the body.

Conveniently, said male socket connection means forms a first electrical contact of said electrical contact means. This helps to simplify construction and assembly.

Conveniently, said male socket connection means comprises an aperture for accommodating a section of said body such that the male socket connection means keys into said section for preventing relative rotation between the male socket connection means and the body. In this way, relative rotation between the male socket connection means and the body is prevented mechanically, without requiring adhesives.

Conveniently, said holding means is for holding a halogen bulb lighting unit.

Conveniently, the cover engages with formations provided on the body for preventing relative rotation between the cover and the body. In this way, once assembled, the housing can be attached to a female lighting unit socket by a user griping and rotating the cover, in the same way as they would with a conventional lighting unit, for example a standard incandescent light bulb.

Conveniently, said formations are configured to provide a gap between the body and the cover. In this way, a space is provided for the escape of convection currents within the glass cover. This minimizes heat accumulation around the lighting unit component, thereby reducing any off-gassing.

Conveniently, the cover comprises an aperture for allowing hot gasses within the cover to escape. This minimises heat accumulation around the bulb component, thereby reducing any off-gassing.

According to a further aspect of the present invention, there is provided a housing for connecting a replaceable lighting unit to a standard lighting unit socket, the housing comprising: a body; male socket connection means provided on said body for connecting to a standard female lighting unit socket; holding means for detachably holding a lighting unit; electrical contact means for connecting a lighting unit held in said holding means to electrical contacts in said female lighting unit socket; and an openable cover attached by mechanical means to said body for covering a lighting unit held by said holding means; wherein the non integral component parts of said housing are held together mechanically without adhesive, for providing a minimal chemical and UV emission signature.

An example of the present invention will now be described with reference to the accompanying drawings in which:-

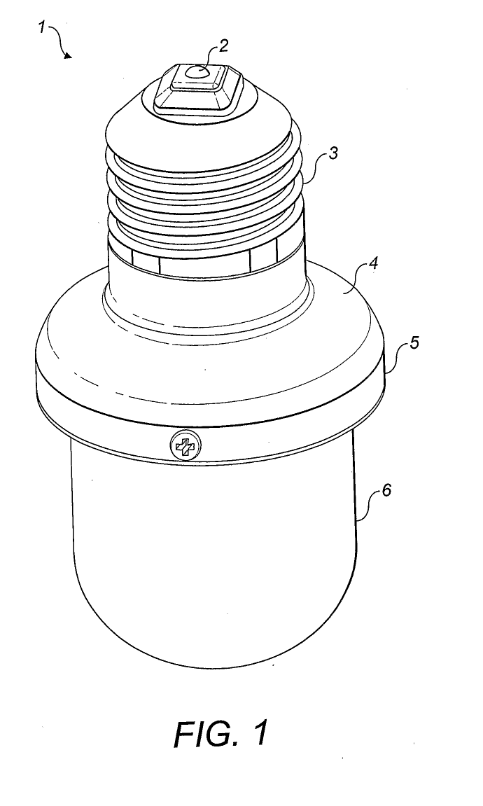

FIG. 1 shows a housing according to an illustrative embodiment of the present invention;

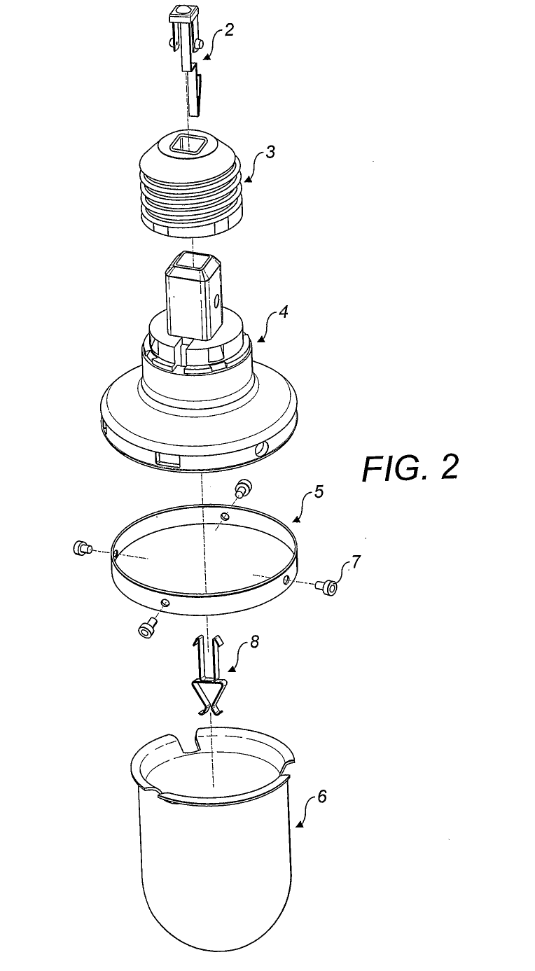

FIG. 2 shows an exploded view of the components forming the housing shown in FIG. 1, excluding the halogen component;

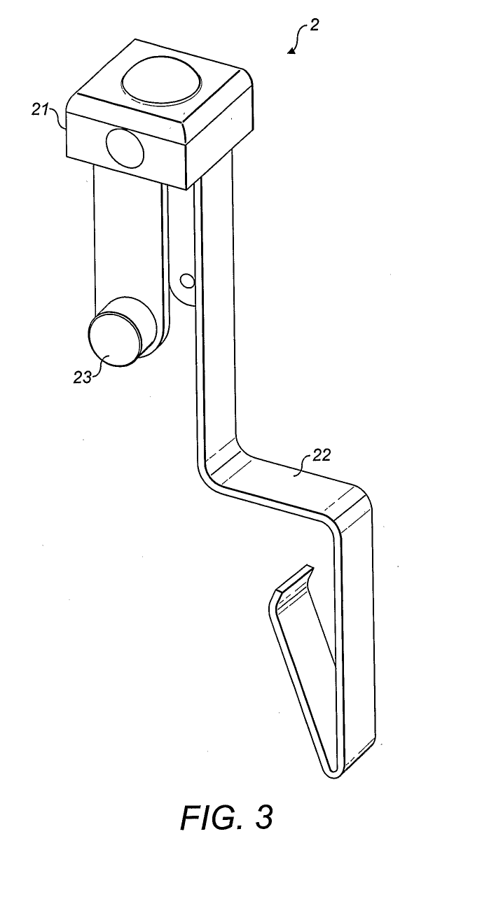

FIG. 3 shows a perspective view of the central contact of the housing;

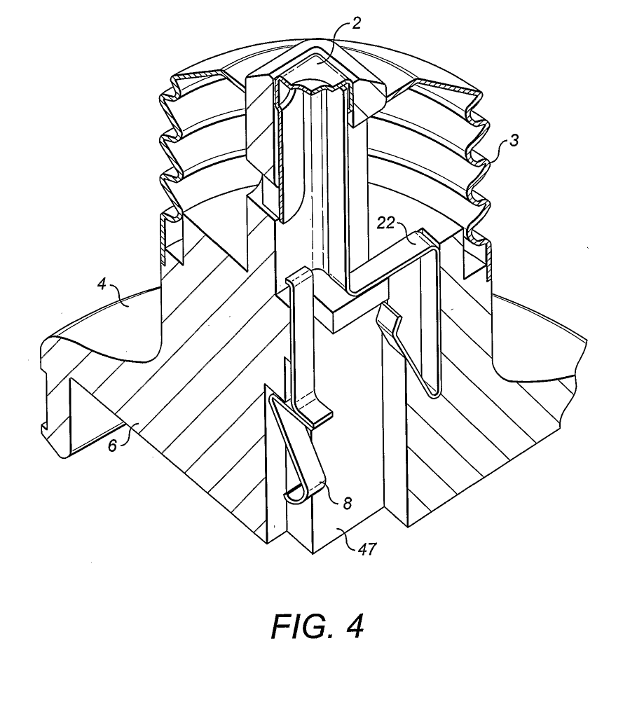

FIG. 4 shows a sectional view taken through the main body of the housing;

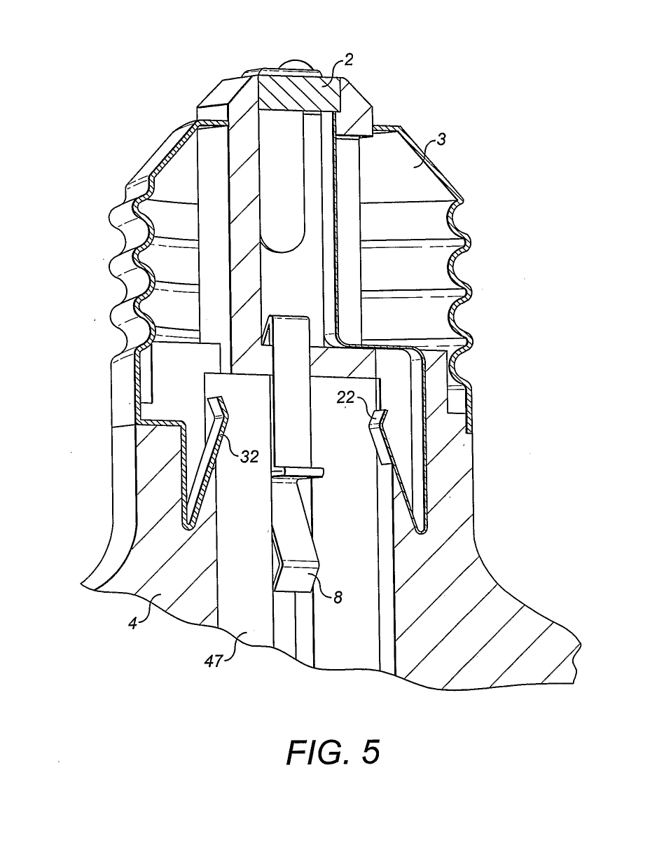

FIG. 5 shows a cross-sectional view taken through the main body of the housing;

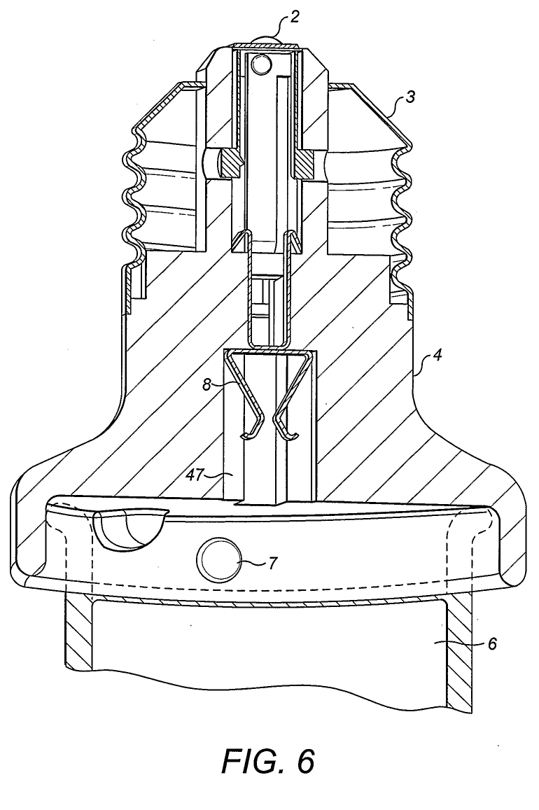

FIG. 6 shows an alternative cross sectional view wherein the main body of the housing has been rotated 90 degrees with respect to the view shown in FIG. 5;

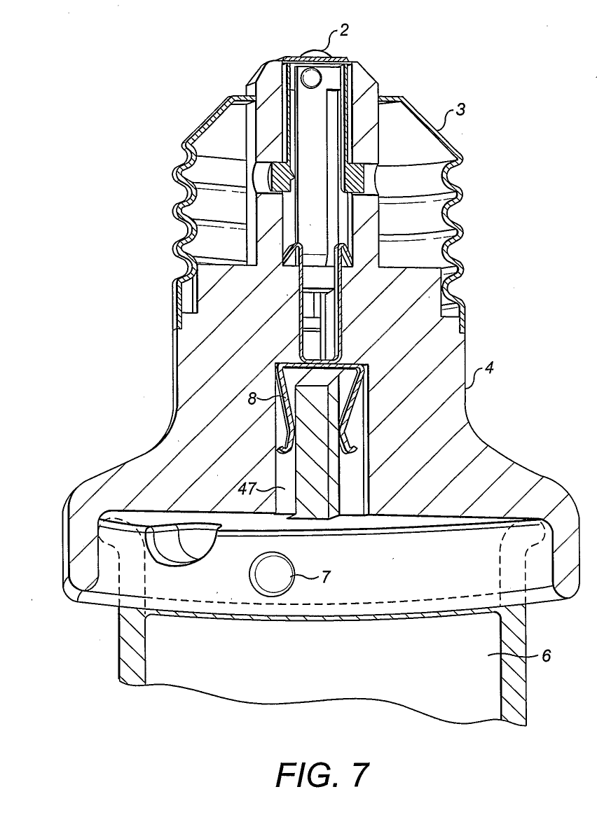

FIG. 7 shows a cross section of the main body of the housing as in FIG. 6, with the halogen bulb component inserted;

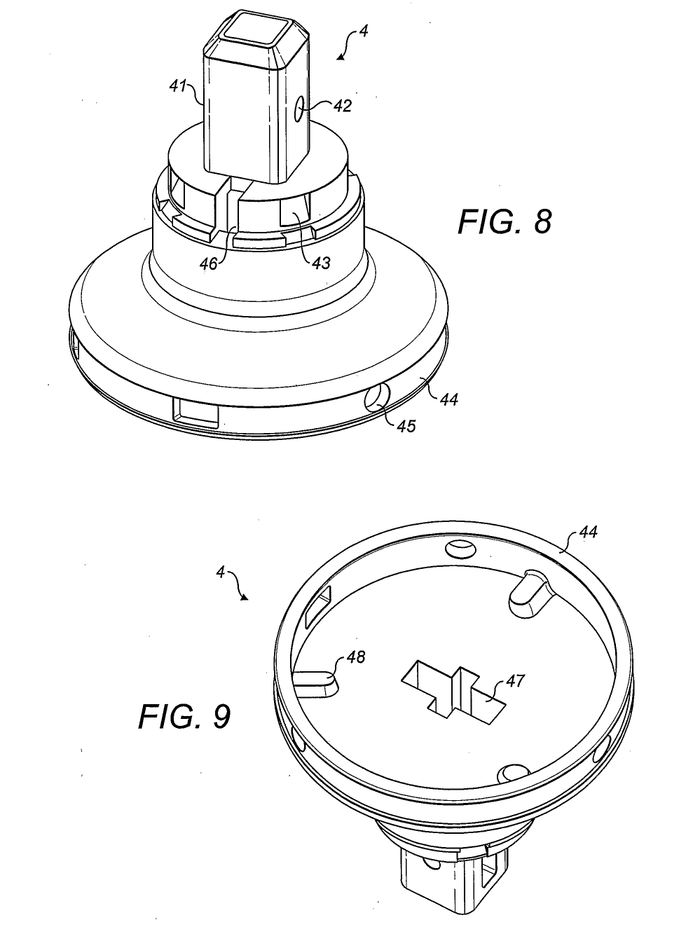

FIG. 8 shows the ceramic body of the housing;

FIG. 9 shows the underside of the ceramic body shown in FIG. 8;

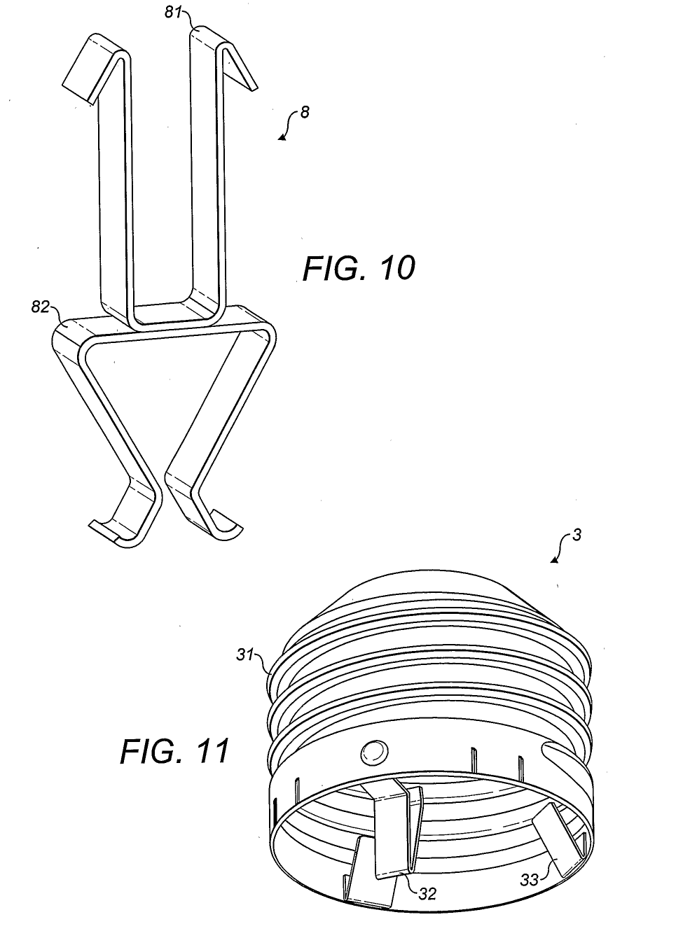

FIG. 10 shows the bulb retainment clip of the housing;

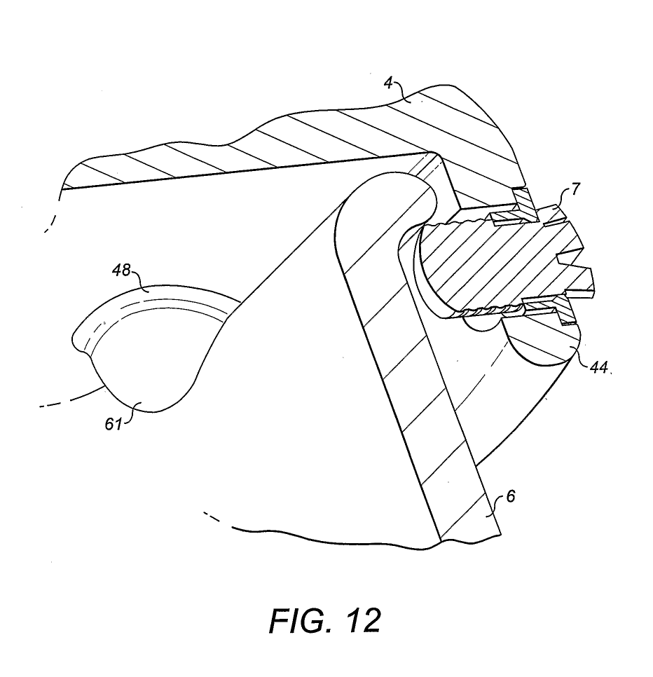

FIG. 11 shows the screw attachment element of the housing; and

FIG. 12 shows the a cross sectional view showing the cover at its attachment to the ceramic body of the housing.

FIGS. 1 and 2 show a housing 1 according to an embodiment of the present invention. The housing 1 takes the form of an adaptor which connects a standard two-pin G9 format halogen bulb component (not shown) to a conventional female light socket, for example an Edison screw light socket as shown in this embodiment.

The housing 1 comprises a body 4 made of a ceramic material moulded to receive the other components. The body 4 is formed as a one piece construction to facilitate easy assembly. A male screw attachment element 3 is attached over the neck of body 4 and retained in positions by clips, as will be described later, and allows the assembled housing 1 to be screwed into a standard female Edison screw light socket. Central contact 2 is inserted through the neck of the body 4 and is insulated from the screw attachment element 3 thereby. The central contact 2 and the screw attachment element 3 are formed of a conductive material, in this case a metal, and act to transfer power from the light socket to the bulb component held within the housing 1. A cover 6 is attached to the body 4 via screw elements 7.

In the present embodiment, a ring 5 formed of a metal is also attached to the body 4 via rivets. Screws 7 are then introduced through apertures provided in the ring 5 in order to engage with and hold the cover 6 in position.

Inside the cover 6, a lighting unit retainment clip 8 is provided. The retainment clip 8 is designed to receive the halogen bulb component (not shown).

The cover 6 is made from glass and is provided in the form of a dome. The purpose of the cover 6 is to filter certain types of radiation, in particular UV (ultra-violet) radiation. In this regard, the cover 6 is vacuum coated with titanium silicon alloy which acts to filter off UV rays.

FIG. 3 shows a perspective view of central contact 2. The central contact 2 is formed of a metal and acts to connect the halogen bulb component, once it is inserted into the bulb component retainment clip 8, to one of the power source contacts on the light socket. For this purpose, the central contact 2 is provided with contact abutment 21 which sits at the top of the neck of the body 4 and contacts with one of the power source terminals in the light socket. Contact leg 22 extends downwardly from the contact abutment 21 and connects to one of the halogen bulb component's pin contacts. Retainment legs 23 are provided with protrusions which insert into formations provided on the neck of body 4 and retain the central contact in position once inserted into the neck of the body 4. In this regard, the tapering of these protrusions ensures there is no free play once they are inserted into the formations on the neck of body 4.

FIGS. 4 and 5 show a sectional views taken through the main body 4 of the housing 1. As can be seen, the central contact 2 is inserted into an aperture provided in the neck of body 4 and the protrusions provided on retainment legs 23 snap-lock into formations to prevent the removal of the central contact 2 once it is inserted. The contact leg 22 extends downwardly into a larger cavity 47 provided within the body 4. In the views shown in FIGS. 4 and 5, the retainment clip 8 has been sectioned such that only one half of the clip is shown.

As can be seen in FIG. 5, the screw attachment element 3 is provided with contact element 32 which extends through an aperture provided in the body 4 and into cavity 47 provided in the body 4 to oppose the contact leg 22. In this way, the contact element 32 and the contact leg 22 form the two power source contacts which connect to the halogen bulb component pin contacts once it is inserted. The central contact 2, including the contact leg 22, is insulated from the screw attachment element 3, including contact element 32, by the ceramic body 4. Furthermore, it will be understood that once screw attachment element 3 has been attached to the body 4, access to the neck of the body 4, and hence the retainment legs 23 of central contact 2, is prevented. This further prevents tampering or disassembly of the housing once assembled.

FIG. 6 shows an alternative cross sectional view wherein the main body of the housing has been rotated 90 degrees with respect to the view shown in FIG. 5. FIG. 7 shows the same view when the halogen bulb component 9 has been inserted into the retainment clip 8. From these views, the entire retainment clip 8 can be seen, in addition to the outline of cavity 47. The base of the halogen bulb component 9 is inserted into cavity 47 and is retained resiliently by the arms of retainment clip 8. Once the halogen bulb component 9 in position, it is orientated so that its pin contacts connect to the contact element 32 and the contact leg 22 shown in FIGS. 4 and 5.

FIG. 8 shows a perspective view of the body 4. As can be seen, the body comprises a neck 41 into which the central contact 2 is inserted. The neck is provided with a square configuration, such that it keys into the aperture provided in the top of screw attachment element 3 to prevent relative rotation of these components. In this way, rotation of the central body causes rotation of the screw attachment element 3 to enable it to be screwed into a screw-type female light socket. An aperture formation 42 is also provided on the neck 41 and into which the protrusions of retainment legs 23 insert, as previously discussed. The main body is also provided with a number of retainment formations 43 into which snap-lock clips on the screw attachment element 3 attach to. Aperture 46 is also provided into which the contact element 32 of screw attachment element 3 inserts into the cavity 47. Finally, the body 4 also has formed therein a skirt 44 and screw apertures 45 which aid to attach the cover 6 to the body 4, as is described later.

FIG. 9 shows the underside of the body 4. As can be seen, the body 4 has a cavity 47 in the centre thereof into which the base of the halogen bulb component (not shown) is inserted. In addition, a number of formations 48 are provided on the undersurface which engage with corresponding formations provided in the cover 6. These formations prevent the cover 6, once attached, from being rotated relative to the body 4. In this way, the assembled housing can be screwed into a female screw light socket by a user griping the cover 6.

FIG. 10 shows the retainment clip 8. The clip is comprised of locking arms 81 which snap-lock the clip into formations provided inside body 4. Extending downwardly from here are two grip arms 82 which resiliently grip the sides of the halogen bulb component, as shown in FIG. 7. Accordingly, the retainment clip 8 is formed of a resilient material, such as a metal. This allows the halogen bulb component to be removed and replaced, if necessary.

FIG. 11 shows a view of the screw attachment element 3 which is formed of a metallic conductive material. The element 3 has a screw thread 31 formed therein which can be screwed into the screw light socket. Snap-lock clips 33 are also provided which lock into the retainment formations 43 provided on the body 4, as discussed above. In addition, contact element 32 is also provided which connects to one of the pin contacts of the halogen bulb component.

FIG. 12 shows a cross sectional view showing the cover 6 at its attachment to the ceramic body 4 of the housing. As can be seen, the cover 6 has a lip on its rim, which sits inside the skirt 44 of the body 4. Once in position, the cover 6 is retained in position by screws 7, which prevent the lip from moving back out of the skirt 44. In addition, cover 6 is provided with formation 61 in the form of slot into which formation 48 of the body 4 fits, as described above. In this way, a mechanical lock between the body 4 and the cover 6 is formed to prevent relative rotation between these components.

As can be seen in FIG. 12, a gap in the vertical axis exists between the lip of cover 6 and the base of body 4. This gap is maintained by the formations 48 and 61, and allows convection currents inside the cover 6 to escape. This minimises heat accumulation around the halogen bulb component, to thereby minimise any off-gassed emissions which may come from the halogen bulb component itself. The gap is preferably in the range of 0.4-0.6 mm. To further minimise heat accumulation, one or more apertures may also be provided in the cover 6 itself, to allow hot air to escape.

From FIG. 12, it can also be seen that a gap is provided between the screw 7 and the side wall of cover 6. This gap is in the range of 0.3-0.6 mm and ensures that even when the screws 7 are fully tightened, the cover 6 will not be damaged by over tightening the screws 7. This gap will also allow space for expansion of screws and glass cover 6.

Accordingly, the present invention provides a housing having an adhesive free construction which allows a low energy bulb component, such as a halogen bulb, to be connected to a standard female light socket. This allows the bulb component to be used in a low emission/low UV emitting way, thereby minimizing the harmful effects which are associated with conventional light bulb constructions.

In this respect, all the components of the present invention are formed of metal or ceramic materials. As such, no adhesives, plastics or paints are employed, which would otherwise cause off-gassing of pollutants.

A further advantage of the present invention is that the housing is reusable. In this regard, the cover 6 is connected to the body by mechanical means, and may be removed or opened by undoing screws 7. This allows a user to access the halogen bulb component and, as this component is held in place by the resilience of bulb component retainment clip 8, remove and replace it with a new bulb component, if necessary. This reduces unnecessary waste and allows the housing of the present invention to be re-used beyond the life span of the original halogen bulb component.

Furthermore, the one piece body 6 and the use snap-lock connections between the conductive components and the body 6 allows for the housing 1 to be made quickly, without adhesives, sealants, or requiring special tools. In addition, once these component parts of the body of the housing have been assembled, it cannot be disassembled. This ensures a sturdy construction and prevents tampering or degradation which could affect the life span of the housing.

It will also be apparent from the above that, despite the construction of the present invention requiring no adhesives or the like, the housing can be attached to a standard female light socket in the same way as a conventional light bulb.

It will be understood that the illustrated embodiment described herein shows an application of the invention in one form only for the purposes of illustration. In practice the invention may be applied to many different configurations the detailed embodiments being straightforward to those skilled in the art to implement.

For example, in the above described embodiment, a Edison screw socket fitting is described. However, the present intention can also be used with alternative fittings, such as a bayonet fitting. Furthermore, in the above embodiment a halogen bulb component has been employed. However, the present invention could also be used with other bulb components, for example flourescent lighting components.

1. A housing for connecting between a replaceable lighting unit and a standard lighting unit socket, the housing comprising:
a main body;
holding means for releasably holding a lighting unit; and
an openable cover for covering a lighting unit held by said holding means;
wherein the cover has a UV filter and the non integral component parts of said housing are held together mechanically without adhesive, for providing a minimal chemical and UV emission signature.

2. A housing according to claim 1, wherein the cover is formed of glass having a coating for absorbing at least 95% of ultra-violet rays.

3. A housing according to claim 2, wherein said coating is a vacuum coating of titanium silicon alloy.

4. A housing according to claim 1, wherein the housing further comprises a male socket connection means provided on said body for connecting to a standard female lighting unit socket.

5. A housing according to claim 4, wherein said socket connection means is a screw fitting for connection to a screw-type female lighting unit socket or a bayonet fitting for connection to a bayonet-type female lighting unit socket.

6. A housing according to claim 1, wherein said body is formed of a ceramic.

7. A housing according to claim 1, further comprising electrical contact means for connecting a lighting unit held in said holding means to electrical contacts in said lighting unit socket, said electrical contact means being attached to the body by snap-lock connection.

8. A housing according to claim 7, wherein the snap-lock connection prevents detachment of the electrical contact means once it is attached to the body.

9. A housing according to claim 8, wherein the snap-lock connections serve as tamper evidence if an attempt is made to detach the electrical contact means from the body.

10. A housing according to claim 1, wherein said holding means is attached to the body by snap-lock connection.

11. A housing according to claim 10, wherein the snap-lock connection prevents detachment of the holding means once it is attached to the body.

12. A housing according to claim 4, wherein said male socket connection means forms a first electrical contact.

13. A housing according claim 4, wherein said male socket connection means comprises an aperture for accommodating a section of said body such that the male socket connection means keys into said section for preventing relative rotation between the male socket connection means and the body.

14. A housing according to claim 1, wherein said holding means is for holding a halogen bulb lighting unit.

15. A housing according to claim 1, wherein the cover engages with formations provided on the body for preventing relative rotation between the cover and the body.

16. A housing according to claim 15, wherein said formations are configured to provide a gap between the body and the cover.

17. A housing according to claim 1, wherein the cover comprises an aperture for allowing hot gasses within the cover to escape.

18. A housing for connecting a replaceable lighting unit to a standard lighting unit socket, the housing comprising:
a body;
male socket connection means provided on said body for connecting to a standard female lighting unit socket;
holding means for detachably holding a lighting unit;
electrical contact means for connecting a lighting unit held in said holding means to electrical contacts in said female lighting unit socket; and
an openable cover attached by mechanical means to said body for covering a lighting unit held by said holding means;
wherein the non integral component parts of said housing are held together mechanically without adhesive, for providing a minimal chemical and UV emission signature.

19. (canceled)
